(19) United States
(12) Patent Application Publication
(10) Pub. No.: US 2014/0258071 A1
(43) Pub. Date: Sep. 11, 2014

(54) METHOD AND SYSTEM FOR CREATING AND TRADING SELLER-PAID MARGIN DERIVATIVE INVESTMENT INSTRUMENTS

(71) Applicant: Chicago Board Options Exchange, Incorporated, Chicago, IL (US)

(72) Inventors: Edward T. Tilly, Barrington, IL (US); William M. Speth, Evanston, IL (US)

(21) Appl. No.: 14/198,256

(22) Filed: Mar. 5, 2014

Related U.S. Application Data
(60) Provisional application No. 61/775,193, filed on Mar. 8, 2013.

(51) Int. Cl. G06Q 40/04

(52) U.S. Cl. CPC G06Q 40/04
USPC 705/37

(57) ABSTRACT

Systems and methods for creating, disseminating and managing margin for a seller-advanced margin derivative investment instrument are disclosed. In one aspect, a seller-advanced margin derivative investment instrument is defined where a seller pre-pays a margin requirement that a buyer typically pays initially as required by an exchange. In another aspect, a collateral management service associated with a clearing entity for an exchange identifies, tracks and notifies seller and buyer clearing firms of margin charges and credits relating to seller-advanced margin derivative investment instruments.

### CROSS-REFERENCE TO RELATED APPLICATION

This application claims the benefit of U.S. Provisional App. No. 61/775,193, filed Mar. 8, 2013, wherein the entirety of the aforementioned application is hereby incorporated herein by reference.

### FIELD OF THE DISCLOSURE

The present disclosure relates to derivative investment markets. More specifically, the present disclosure relates to aspects of actively creating, disseminating, and trading derivatives where a seller initially pays a buyer's margin requirement.

### BACKGROUND

A derivative is a financial security whose value is derived in part from a value or characteristic of another security, known as an underlying asset. Two exemplary and well known derivatives are options and futures.

An option is a contract that gives the contract holder a right, but not an obligation, to buy or sell an underlying asset at a specific price on or before a certain date. Generally, a party who purchases an option is referred to as the holder of the option and a party who sells an option is referred to as the writer of the option.

There are generally two types of options: call and put options. A holder of a call option receives a right to purchase an underlying asset at a specific price, i.e., the “strike price.” If the holder exercises the call option, the writer is obligated to deliver the underlying asset to the holder at the strike price. Alternatively, the holder of a put option receives a right to sell an underlying asset at a specific price, i.e., the “strike price.” If the holder exercises the put option, the writer is obligated to purchase the underlying asset at the agreed upon strike price. Thus, the settlement process for an option may involve the transfer of funds from the purchaser of the underlying asset to the seller of the underlying asset, and the transfer of the underlying asset from the seller of the underlying asset to the purchaser of the underlying asset. This type of settlement may be referred to as “in kind” settlement. However, an underlying asset of an option need not be tangible, transferable property.

Options may also be based on more abstract market indicators, such as stock indices, interest rates, futures contracts and other derivatives. In these cases, “in kind” settlement may not be desired and/or possible. In these cases, the contracts are “cash settled.” For example, using cash settlement, a holder of an index call option receives the right to “purchase” not the index itself, but rather a cash amount equal to the value of the index multiplied by a multiplier, e.g., $100. Thus, if a holder of an index call option exercises the option, the writer of the option must pay the holder the difference between the current value of the underlying index and the strike price multiplied by the multiplier. However, the holder of the index will only realize a profit if the current value of the index is greater than the strike price. If the current value of the index is less than or equal to the strike price, the option is worthless due to the fact that the holder would realize a loss.

Similar to options contracts, futures contracts may also be based on abstract market indicators. Futures contracts give a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not change hands. Instead, futures contracts may be cash settled. To cash settle a future, the difference between a market price and a contract price is paid by one investor to the other. Again, like options, cash settlement allows futures contracts to be created based on more abstract “assets” such as market indices. To cash settle index futures, the difference between the contract price and the price of the underlying asset (i.e., current value of market index) is exchanged between the investors to settle the contract.

Derivatives such as options and futures may be traded over-the-counter (OTC), and/or on other trading facilities such as organized exchanges. In over-the-counter transactions the individual parties to a transaction are free to customize each transaction as they see fit. With trading platform-traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading platform, and will typically be related to the value of the underlying asset.

In OTC option trading, a customer may be required to put up collateral for a trade, or a trade may go forward on a hand-shake/good faith basis depending on the type of customer of the option. In option exchanges, buyers and sellers of options are each generally held to predetermined margin requirements. Buyers of options can buy equity options and equity index options on margin in certain circumstances, for example if the option has more than nine (9) months until expiration. The initial (maintenance) margin requirement may be 75% of the cost (market value) of a listed, long term equity or equity index put or call option. One who takes a “long” position in a non-marginable put option or call option is required to pay the premium amount in full.

In the options market, “margin” also means the cash or securities required to be deposited by an option writer with his brokerage firm as collateral for the writer's obligation to buy or sell the underlying interest, or in the case of cash-settled options to pay the cash settlement amount, if assigned an exercise. Minimum margin requirements currently are imposed by the options markets and other self-regulatory organizations, and higher margin requirements may be imposed either generally or for certain positions by the various brokerage firms.

### BRIEF SUMMARY

Accordingly, the present disclosure relates to methods and systems for trading a form of derivative investment instrument where a seller of the derivative investment instrument advances any margin required by the buyer at the time of the order.

According to one aspect, a computer-implemented method of managing a seller-advanced margin option on an electronic exchange is disclosed. Using a processor of a clearing entity associated with the electronic exchange, where the clearing entity is configured to monitor aggregate margin risks of clearing firms associated with buyers and sellers of seller-advance margin options, the processor receives information relating to matched orders from the electronic exchange. The information may be automated messages identifying a matched trade for a seller-advanced margin option between a buyer and a seller, wherein the automated message includes information identifying that the matched trade is for the seller-advanced margin option. The processor may transmit a first margin position notice communication to a clearing firm of the seller of the seller-advanced margin option, where the margin position notice communication contains aggregate margin position information for all customers of the clearing firm of the seller, and where the aggregate margin position information includes a margin obligation of the seller totaling a sum of margin requirements for both the buyer and the seller of the matched trade of the seller-advanced margin option. Subsequent to transmitting the first margin position notice, the processor may transmit a second margin position notice to the clearing firm of the seller. The second margin position notice may comprise second aggregate margin position information including a repayment by the buyer to the seller of at least a portion of the margin obligation of the buyer of the seller-advanced margin option.

In various alternatives transmitting the second margin position notice to the clearing firm of the seller may include transmitting the second notice in response to an expiration of the seller-advanced margin option or in response to receipt of a message from the electronic exchange that the buyer has closed out a position in the seller-advanced margin option.

Alternatively, transmitting the second margin position notice to the clearing firm of the seller may include transmitting a plurality of second margin notices at a predetermined interval after receiving the automated notice identifying the matched trade and prior to expiration of, or closing out of a position in, the seller-advanced margin option. Each of the second margin notices may reflect information relating to repayment from the buyer to the seller of only a respective portion of the margin requirement of the buyer. The respective portions may be equal or may differ dynamically, for example based on a current mark-to-market value of the seller-advanced margin option. A clearing system configured to accomplish the above margin management techniques is also disclosed.

### BRIEF DESCRIPTION OF THE DRAWINGS

FIG. 1 is a flow diagram of steps for implementing seller-advanced margin financial instruments;

FIG. 2 is a block diagram of and exchange system for creating and trading seller-advanced margin financial instruments; and

FIG. 3 illustrates an exchange back-end system for use in the exchange system of FIG. 2

FIG. 4 illustrates order and margin flow for a standard option;

FIG. 5 illustrates an order and margin flow for a seller-advanced margin option utilizing a collateral management system; and

FIG. 6 is an illustrative embodiment of a general computer system usable as one or more of the components of FIGS. 2-5.

### DETAILED DESCRIPTION OF THE DRAWINGS

Exchange traded derivative instruments, such as options, are typically bought and sold by parties through their respective clearing firms, where the clearing firms have a contractual agreement with their respective customers (e.g. traders) to handle the finances of their customers relating to trades on an exchange. The clearing firms generally require that their customers maintain a margin account to pay the margin that the exchange and/or regulatory agency overseeing the exchange requires for each trade. A clearing house, such as the Options Clearing Corporation used in options trading, stands between the clearing firms and handles tasks including netting offsetting transactions between the counterparties, requiring the necessary margin deposits from the clearing firms, providing independent valuation of trades, and monitoring the credit worthiness of the clearing firms. In options trading and security markets, the clearing house typically only knows the aggregate position of the various clearing firms it works with, but not the details of each customer at each clearing firm. In futures markets, due to futures-specific regulations, the clearing house typically knows both the individual account status and the clearing firm net position. The clearing firms monitor and charge or credit their respective customers' margin accounts based on the aggregate margin information received from the clearing house (OCC). In a standard option trade, both the seller and the buyer have respective margin requirements.

In order to provide more flexibility to buyers and sellers of derivative investment instruments, a system and method for providing a seller-advanced margin derivative is described. The seller-advanced margin derivative may be for the same underlying as a standard derivative, but contractually require a different distribution of margin. Thus, while the same total margin required by an exchange or regulatory agency is also required in the seller-advanced derivative instrument, the seller is initially required to pay both the seller margin and the buyer margin for a seller-advanced margin derivative investment instrument. The seller-advanced margin derivative investment instrument may be quoted disseminated and displayed on a display device with a unique marker or symbol alongside standard derivatives for the same underlying at an exchange. The seller-advanced margin derivative, however, may be quoted at a higher price than a counterpart standard derivative having the same underlying. The higher premium a buyer of such a derivative would pay to the seller is due to the extra financing and risk taken on by the seller. As with standard options, the price that different sellers may quote to sell such a derivative investment instrument may vary based on the costs and profit each seller feels is appropriate, where the sellers for this type of derivative investment instrument compete with each other on price to attract buyers. In one embodiment, each seller of a seller-advanced margin derivative instrument may offer such a derivative instrument concurrently with standard options for the same underlying asset, but at a price higher than the standard option to reflect the extra financing and risk costs the seller of such a derivative may face.

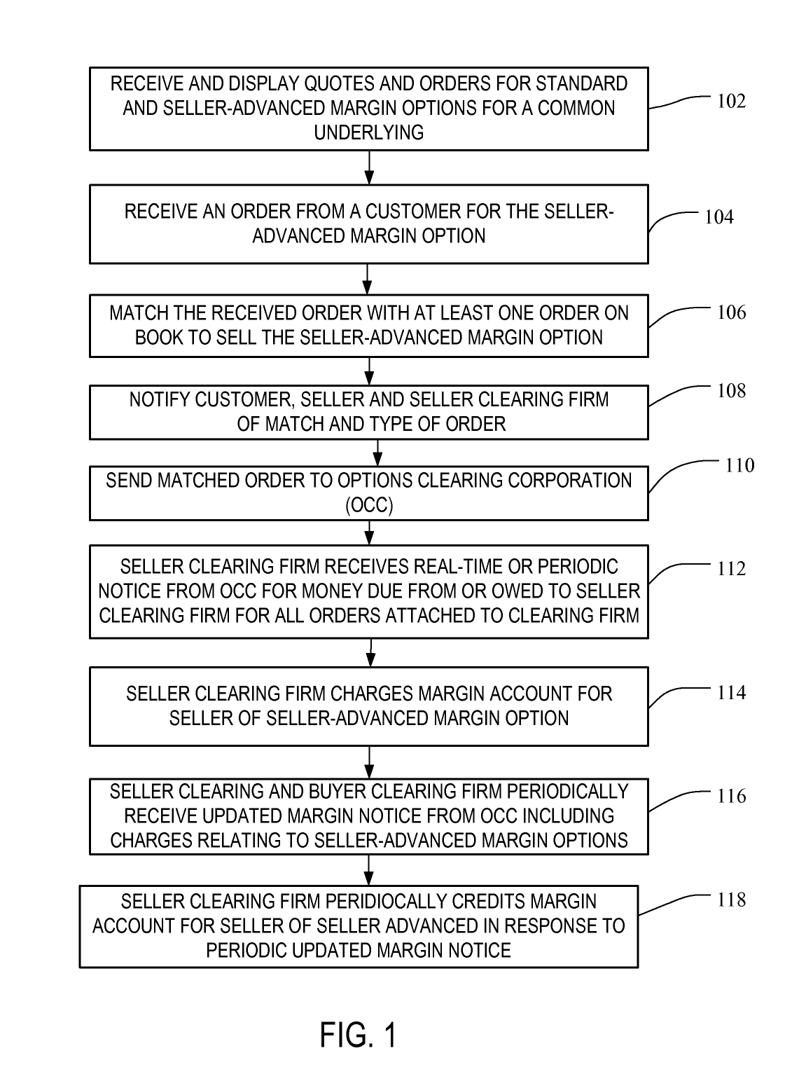

One embodiment of the process of trading and managing seller-advanced margin derivative investment instruments is illustrated in the flow chart of FIG. 1. An exchange may receive quotes and orders for standard options (i.e. those where the buyer and seller each post their own margin requirement for the transaction) as well as seller-advanced margin options for the same underlying (at 102). The seller-advanced margin option being defined at the exchange as requiring the seller to initially post the margin for the buyer and the buyer being required to pay back the seller at a designated time, or over a designated period of time. As with standard options, the exchange may receive orders for the seller-advanced margin option (at 104). The exchange may match a received order to buy with one or more previously received quotes or orders from sellers of the seller-advanced margin option using a standard trade engine that may implement one or more known allocation methods to automatically allocate the order among the various sellers vying for the order (at 106).

When the electronic trade engine of the exchange matched the orders to buy and sell the seller-advanced margin option, the exchange may automatically notify the buyer, seller and their respective clearing firms of the match (at 108). Upon matching the buy and sell orders, the electronic trade engine of the exchange may automatically transmit an electronic message to the clearing entity for the exchange, which in the case of options trading may be the Options Clearing Corporation (OCC) (at 110). In one embodiment, the electronic message to the OCC may be in real-time. In other embodiments, the electronic trade engine may periodically send messages containing trade match information in batches to the OCC.

The OCC may, in real-time or periodically during a trading day, send the seller clearing firm a notice regarding margin amounts due from or owed to the clearing firm (at 112). The notice may be sent electronically and may include an aggregate amount owed to/from all the customers (buyers and sellers) at the seller's clearing firm. The seller's clearing firm, using the aggregate margin position information received from the OCC and the knowledge of the match information for the seller, will charge the margin account of each of the sellers (there may be just a single seller in some trades) that took part in the trade of the seller-advanced margin options for their respective share of the buyer's margin they are required to advance, in addition to the seller's typical margin required (at 114). As explained in more detail below, although the buyer of a seller-advanced margin option does not initially pay the typical buyer margin required for a trade, the buyer is ultimately responsible for paying back the seller for the buyer margin. This repayment may be a lump sum upon closing out of the position or a periodic calculated payment. The seller's clearing firm and the buyer's clearing firm will receive periodic notices from the OCC with their respective current margin positions (at 116). The clearing firm position information reflected in these notices may include any amount of margin owed by the buyer to the seller after a seller-advanced margin option trade is executed based on the method of margin repayment associated with the specific seller-advanced margin option contract. The buyer clearing firm, the seller clearing firm and the OCC will all know the proper repayment formula based on the specific predetermined repayment rules associated with the seller-advanced margin option in question. Thus, the seller's clearing firm may periodically credit the seller's margin account (and the buyer's clearing firm debit the buyer's margin account a matching amount) in response to receiving the periodic margin position notice from the OCC after execution of the seller-advanced margin option trade (at 118).

The method for creating and trading a seller-advanced margin derivative contract begins by identifying an underlying asset or a set of underlying assets for the seller-advanced margin derivative contract. Typically, an underlying asset or set of assets is selected based on trading volume of a prospective underlying asset, the general level of interest of market participants in a prospective underlying asset, or for any other reason desired by a trading platform. The underlying asset for the seller-advanced margin derivative contract may be equity indexes or securities; fixed income indexes or securities; foreign currency exchange rates; interest rates; commodity indexes; commodity or structured products traded on a trading platform or in the over-the-counter (“OTC”) market; or any other type of underlying asset whose value may change from day to day.

Generally, a seller-advanced margin derivative contract may be listed on an electronic platform, an open outcry platform, a hybrid environment that combines the electronic platform and open outcry platform, or any other type of platform known in the art. One example of a hybrid exchange environment is disclosed in U.S. Pat. No. 7,613,650, filed Apr. 24, 2003, the entirety of which is herein incorporated by reference. Additionally, a trading platform, such as an exchange, may transmit seller-advanced margin derivative contract quotes of liquidity providers over dissemination networks to other market participants. Liquidity providers may include designated primary market makers (“DPM”), market makers, locals, specialists, trading privilege holders, registered traders, members, or any other entity that may provide a trading platform with a quote for a variance derivative. Dissemination networks may include networks such as the Options Price Reporting Authority (“OPRA”), the OBOE Futures Network, an Internet website or email alerts via email communication networks. Market participants may include liquidity providers, brokerage firms, normal investors, or any other entity that subscribes to a dissemination network. The trading platform executes buy and sell orders for the seller-advanced margin derivative in the same manner as standard options for the same underlying where the buyer and seller initially pay their own margin amounts separately.

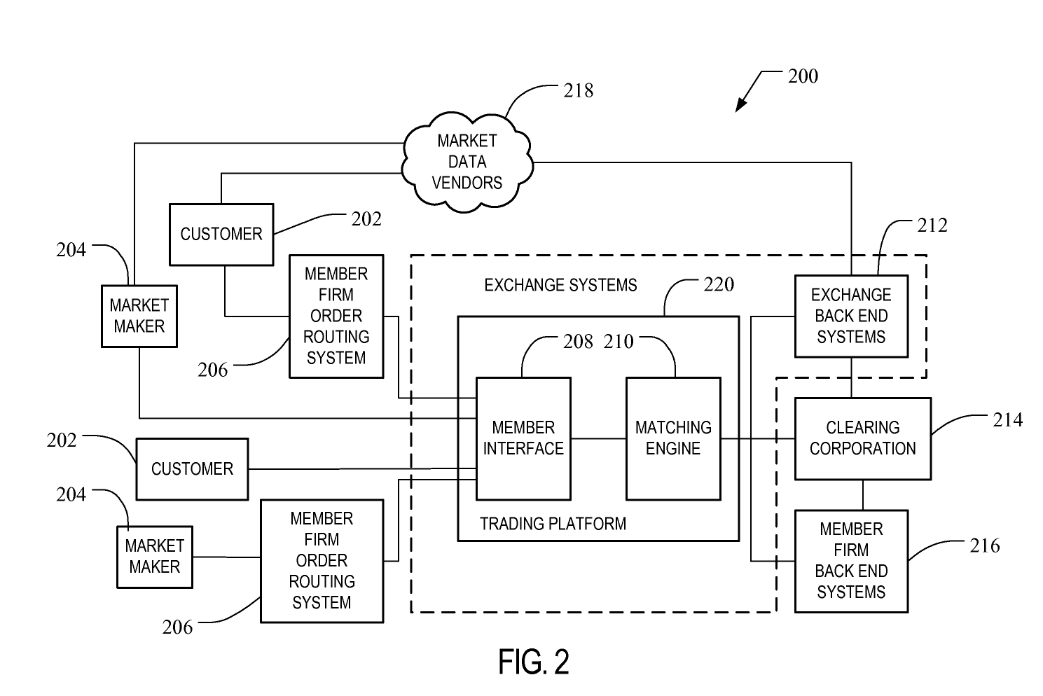

FIG. 2 illustrates an electronic trading system 200 which may be used for creating and disseminating seller-advanced margin derivative contracts. It will be appreciated that the described systems may implement the methods described above with respect to FIG. 1. The system 200 includes components operated by an exchange, as well as components operated by others who access the exchange to execute and settle trades. The components shown within the dashed lines are those operated by the exchange. Components outside the dashed lines are operated by others, but nonetheless are necessary for the operation of a functioning exchange. The exchange components of the trading system 200 include an electronic trading platform 220, a member interface 208, a matching engine 210, and backend systems 212. Backend systems not operated by the exchange but which are integral to processing trades and settling contracts are the Option Clearing Corporation's systems 214, and member firms' backend systems 216.

Market makers may access the trading platform 220 directly through personal input devices 204 which communicate with the member interface 208. Market makers may quote prices for seller-advanced margin derivative contracts. Non-member Customers 202, however, must access the exchange through a member firm. Customer orders are routed through member firm routing systems 206. The member firms' routing systems 206 forward the orders to the exchange via the member interface 208. The member interface 208 manages all communications between the member firm routing systems 206 and market makers' personal input devices 204; determines whether orders may be processed by the trading platform; and determines the appropriate matching engine for processing the orders. Although only a single matching engine 210 is shown in FIG. 2, the trading platform 220 may include multiple matching engines. Different exchange traded products may be allocated to different matching engines for efficient execution of trades. When the member interface 208 receives an order from a member firm routing system 206, the member interface 208 determines the proper matching engine 210 for processing the order and forwards the order to the appropriate matching engine. The matching engine 210 executes trades by pairing corresponding marketable buy/sell orders. Non-marketable orders are placed in an electronic order book.

Once orders are executed, the matching engine 210 sends details of the executed transactions to the exchange backend systems 212, to the Clearing Corporation systems 214, and to the member firms' backend systems 216. The matching engine also updates the order book to reflect changes in the market based on the executed transactions. Orders that previously were not marketable may become marketable due to changes in the market. If so, the matching engine 210 executes these orders as well.

The exchange backend systems 212 perform a number of different functions. For example, contract definition and listing data originate with the Exchange backend systems 212. The seller-advanced margin derivative contract prices are disseminated from the exchange backend systems to market data vendors 218. Customers 202, market makers 204, and others may access the market data regarding the seller-advanced margin derivative contracts via, for example, proprietary networks, on-line services, and the like. The exchange backend systems also evaluate the underlying asset or assets on which the seller-advanced margin derivative contracts are based. At expiration, the backend systems 212 determine the appropriate settlement amounts and supply final settlement data to the Clearing Corporation. The Clearing Corporation acts as the exchange's bank and performs a final mark-to-market on member firm margin accounts based on the positions taken by the member firms' customers (including public customers and market makers). The final mark-to-market reflects the final settlement amounts for the seller-advanced margin derivative contracts, and the Clearing Corporation debits/credits member firms' accounts accordingly. These data are also forwarded to the member firms' systems 216 so that they may update their customer accounts as well.

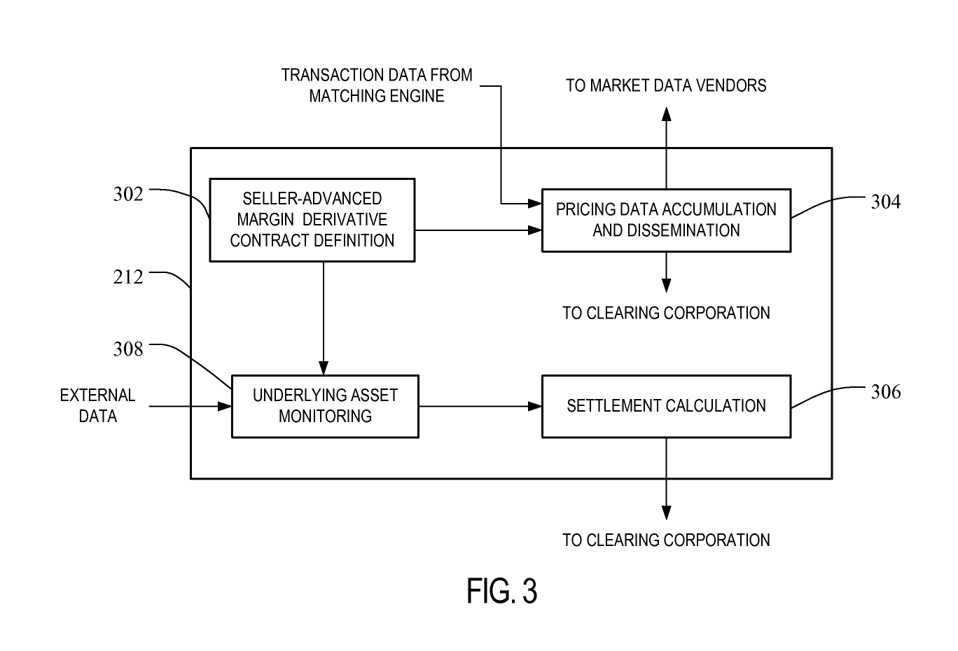

FIG. 3 shows an example of exchange backend systems 212 that may be used for creating, listing and trading seller-advanced margin derivative contracts in more detail. A seller-advanced margin derivative contract definition module 302 stores all relevant data concerning the seller-advanced margin derivative contract to be traded on the trading platform 220, including, for example, the contract symbol, a definition of the underlying asset or assets associated with the seller-advanced margin derivative, or a term of a calculation period associated with the seller-advanced margin derivative. A pricing data accumulation and dissemination module 304 receives contract information from the seller-advanced margin derivative contract definition module 302 and transaction data from the matching engine 210. The pricing data accumulation and dissemination module 304 provides the market data regarding open bids and offers and recent transactions to the market data vendors 218. The pricing data accumulation and dissemination module 304 also forwards transaction data to the Clearing Corporation so that the Clearing Corporation may mark-to-market the accounts of member firms at the close of each trading day, taking into account current market prices for the seller-advanced margin derivative contracts. Finally, a settlement calculation module 306 receives input from the seller-advanced margin derivative monitoring module 308. On the settlement date the settlement calculation module 306 calculates the settlement amount based on the seller-advanced margin derivative value associated with the underlying asset or assets. The settlement calculation module 306 forwards the settlement amount to the Clearing Corporation, which performs a final mark-to-market on the member firms' accounts to settle the seller-advanced margin derivative contract.

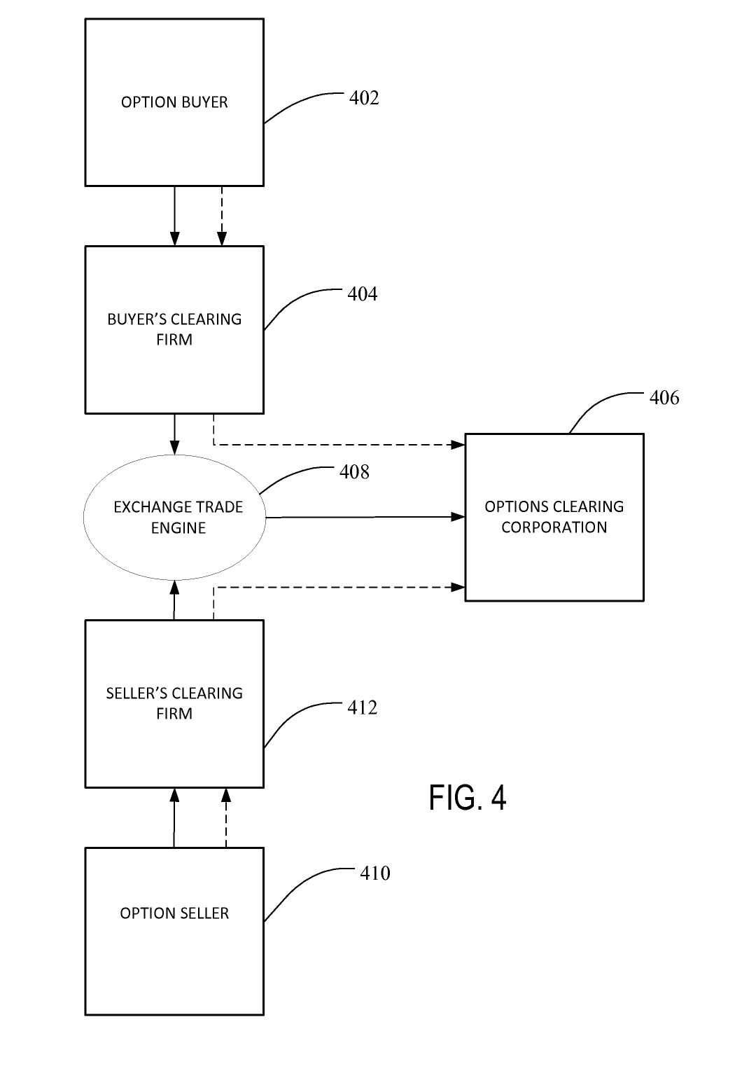

In order to better understand the flow of margin payments in seller-advanced margin options, it is useful to first look at a typical flow of margin payments for standard options. Referring to FIG. 4, a standard option order flow and money flow are illustrated for options where the buyer and seller each pay their own margin requirements up front. In FIG. 4, the solid lines represent position flow information, while the dashed lines represent margin flow. The margin requirements may be calculated according to the exchange requirements of the exchange the parties are trading on, the regulatory agency overseeing the exchange or both. For a standard option order where an option buyer 402 enters an order to purchase standard options via the buyer's clearing firm 404, the buyer forwards the appropriate margin amount to the buyer's clearing firm 404, or authorizes the buyer's clearing firm 404 to debit the buyer's margin account at the buyer's clearing firm. Similarly, the option seller 410 of the option pays, or authorizes a debit of a margin account at, the seller's clearing firm 412 for margin payment for the seller's margin when the seller 410 enters an order to sell the 100 standard options.

The seller's and buyer's clearing firms 412, 404 risk manage trades for all of their respective customers' accounts and collect margin from their customers. When the buyer's clearing firm makes a margin payment to the clearing corporation, the payment reflects netted positions across all accounts for the buyer's clearing firm 404. Similarly, when the seller's clearing firm 412 makes a margin payment to the clearing corporation 406, the margin payment reflects netted positions across all accounts for the seller's clearing firm. The clearing corporation 406 provides risk management for the clearing firms 404, 412 and collects margins from all clearing firms.

If the buyer 402 wishes to enter an order, for example an order to buy 100 standard options at $10, the option buyer 402 sends the order and the $100,000 margin payment (or authorization to debit an already funded margin account) to the buyer's clearing firm 404. The option seller 410 may send in an order to sell 100 of the standard options at $10. The option seller 410 sends the order to sell and the $200,000 margin payment or authorization to the seller's clearing firm 412. The orders to buy and sell are sent to the trade engine 408, such as the matching engine 210 of FIG. 2, matched by the trade engine 408 and reported to the clearing corporation 406. Separately, the margin payments from the buyer and seller are sent directly to the clearing corporation 406 by their clearing firms 404, 412 after they have been netted with margin requirements for all accounts at their respective clearing firms. Any of a number of formulaic predetermined margin calculations may be used and the above numbers are provided only for purposes of illustration.

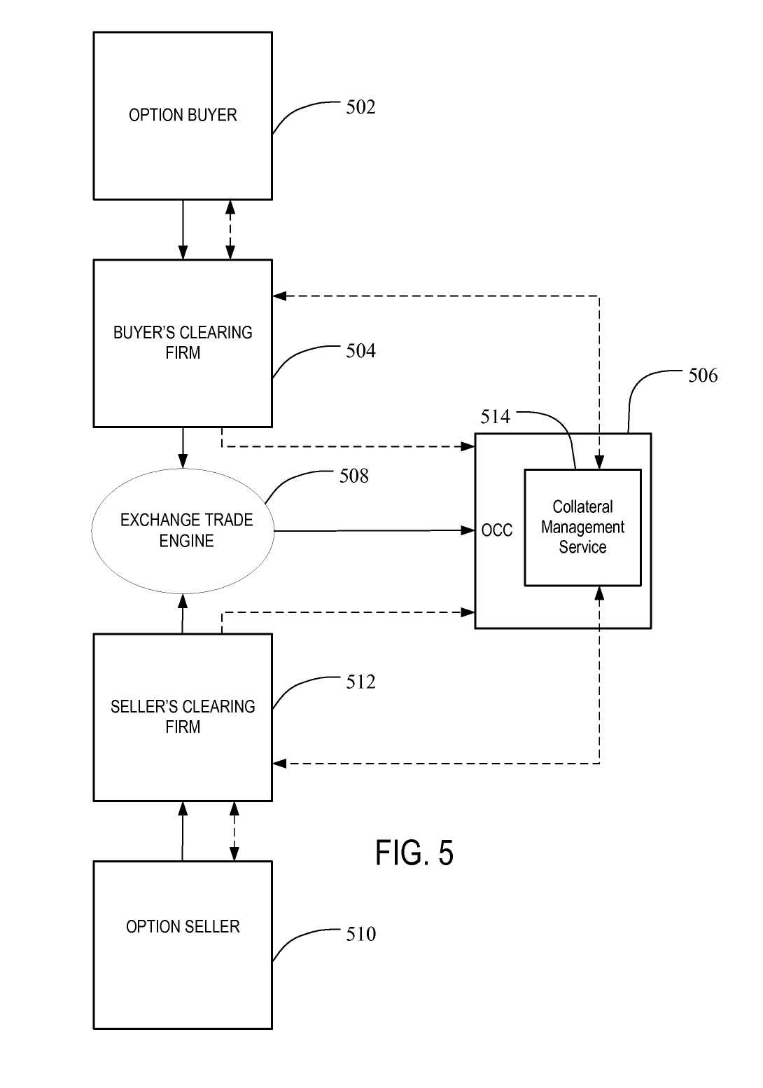

In contrast to the standard option margin flow of FIG. 4, FIG. 5 illustrates an example of a seller-advanced margin flow of FIG. 1. As in FIG. 4, the solid lines represent position flow information, while the dashed lines represent margin flow. In the example flow of FIG. 5, some or all of the exchange trade engine 508, clearing firms 504, 512, and Options Clearing Corporation 506 may include functionality recognizing the seller-advanced margin option as needing a margin flow different that the standard option margin flow. For example, one or more of these components may recognize a different symbol used by the seller-advanced option such that predetermined information on a non-standard margin flow may be passed on to the clearing corporation 506. In addition to the ability to recognize the different types of orders (standard option versus seller-advanced margin option), an additional service that may be necessary is to manage the specific customized tracking of repayment that needs to occur to the seller by the buyer of the seller-advanced margin. As noted previously, each of the clearing firms manages individual customer accounts and provides an aggregate payment relating to the total positions for their respective customers to the Options Clearing Corporation 506. The Options Clearing Corporation generally only knows about which clearing firms 504, 512 are associated with which trades, but not which individual customers of the clearing house are associated with the specific trades.

To help act as an intermediary between the parties in the collection of the buyer's margin requirement from the seller and the subsequent re-payment of that margin when the option position is closed or expires, a collateral management service (CMS) 514 is utilized. This collateral management service 514 may be a functions or routines running on one or more computers at the Options Clearing Corporation 506 or may be offered by some other clearing house or exist as a separate entity on its own with infrastructure capable of managing daily or intraday payments and collections for multiple counterparties. The CMS 514 may be involved in a seller-advanced margin option transaction by initially informing the seller's clearing firm 512 that it owes the margin for the buyer 302 for the particular seller-advanced margin option trade. The CMS 514, upon the conclusion of the trade for the seller-advanced margin option would then participate in reminding the buyer's clearing firm and seller's clearing firm 504, 512 of their respective repayment or credit positions for any seller-advanced margin option trades. As an example of a transaction process where the OCC 506 contains the CMS 514 and a seller-advanced margin option trade is initiated, orders would be received at the exchange trade engine 508 and both the option buyer and seller 502, 510 and the respective clearing firms 504, 512 would get a fill report if their respective orders are matched. Accordingly, the matched order would be sent to the Options Clearing Corporation 506 for clearing. In a real-time manner, or periodically, the OCC 506 would take stock of the net positions at the buyer's clearing firm 504 and seller's clearing firm 512 and ask for or pay back margin in accordance with their current netted positions. Concurrently, the clearing firms 504, 512 would allocate the risk to the proper account belonging to their customers. In the case of a standard option, the margin requirements would be calculated by the OCC 506 to charge the buyer and seller's firms, respectively, with their necessary margin.

In instances where the matched order information forwarded to the OCC 506 relates to a seller-advanced margin option, where the symbol or other information relating to the trade is recognized at the collateral management service 514 as triggering an event margin requirement, the collateral management service 514 would work with the OCC 506 to inform the seller's clearing firm of its extra margin requirement. This would be part of the aggregate firm position that the OCC would update the seller's clearing firm for and would not identify the particular customer of the seller's firm instead, the seller's clearing firm 512 would recognize from the matched order information it received from the exchange trade engine 508 that the option sellers 510 order for selling a seller-advanced margin option would incur greater margin requirements from that seller's account at the seller's clearing firm 512. Accordingly, the buyer's clearing firm 504 would only receive an aggregate net position message from OCC 506 and would know, on its own, that its customer the option buyer 502 was not immediately responsible for payment of the buyer's margin for the seller-advanced margin option order.

Although the option buyer 502 and buyer's clearing firm 504 are not initially responsible for the margin for the seller-advanced margin option trade, they are responsible for ultimate repayment of that entire amount of the initial margin and any subsequent maintenance amounts. Repayment of the initial margin that was advanced by the seller can be accomplished in multiple ways. In one embodiment, the buyer of a seller-advanced margin option would make no margin payments during the holding period of the option contract. When the option buyer 502 closes a seller-advanced margin option position, or the seller-advanced margin option expires, the options buyer 502 must deliver to the collateral management service 514 the total of all margin payments by the seller on behalf of the buyer. The collateral management service 514 would then forward that information to the OCC 506 which, in turn, calculates into the margin amount for the aggregate position for the seller's clearing firm 512 any credit coming from repayment of the margin by the buyer's clearing firm 504. The seller's clearing firm 512, knowing the information relating to the expiration or closing of the position, would calculate on its own the fact that the portion of its current margin obligations that have been refunded should go to the option seller 510 as repayment of the option seller's advancement of the margin for that particular trade.

In an alternative embodiment, the option seller 510 still pays the initial margin and any subsequent maintenance amount as required (e.g., for contracts that initially have more than nine months to expiration). However, in this embodiment of repayment, the option buyer 502 of a seller-advanced margin option delivers to the CMS 514, for example via the buyer's clearing firm 504, periodic re-payments of the advanced margin over the holding period of the contract. The balance of the periodic payments may reflect the difference between the daily mark-to-market price of the seller-advanced margin option and its original purchase price. In this embodiment, both the buyer's clearing firm 504 and the CMS 514 would each know the formula for repayment. The buyer's clearing firm 504 and collateral management service 514 would utilize information from the exchange trade engine 508 to determine the daily mark-to-market price. The buyer's clearing firm 504 would debit the option buyer's 502 margin account, or directly receive payments from the option buyer 502. The CMS 514 would enforce repayment of the periodic margin from the buyer's clearing firm. Simultaneously, the CMS 514 would credit the seller's clearing firm 512 so that the seller's clearing firm would, in turn, credit the option seller 510 margin account with the periodic payment.

In another alternative embodiment of the seller-advanced margin payment, the option seller, again, would pay the initial margin and any subsequent maintenance amounts as required. However, in this embodiment, the option buyer 502 of the seller-advanced margin option would deliver to the CMS 514 a periodic repayment over the holding period of the contract where the amounts of the periodic payment would reflect a straight-line amortization of the option buyer's 502 deferred margin requirement through the expiration date of the seller-advanced margin option. If the option buyer 502 of the seller-advanced margin option closes the position prior to expiration, the option buyer 502 delivers to the CMS 514 all remaining balance of the deferred margin requirement. And, as with the first periodic repayment option noted about, the CMS 514 and the buyer's and seller's clearing firms 504, 512 each separately calculate the payment or credit period using the same known formula, where the clearing firms 502, 512 each handle the translation of a netted firm position to the appropriate customer account and the CMS 514 calculates each respective firm's obligation or credit that it provides to the OCC 506 which gets transmitted to each of the firms as a netted position that needs to be distributed by the respective firms to the appropriate customers of those firms. In one embodiment, the credit amounts may be routed through the CMS 514 from the buyer's clearing firm to the seller's clearing firm. In alternative embodiments, the buyer's clearing firm could make repayment of that option buyer's margin obligations directly to the seller's clearing firm 512 with a message being sent in confirmation by the seller's clearing firm to CMS 514 confirming that the buyer's clearing firm, and specifically the option buyer for the buyer's clearing firm, had paid up on some or all of the margin obligation from the seller-advanced margin option transaction. In yet other embodiments, one or both of the option seller and option buyer may transfer margin payments directly to and from the collateral management service without going through their respective clearing firms.

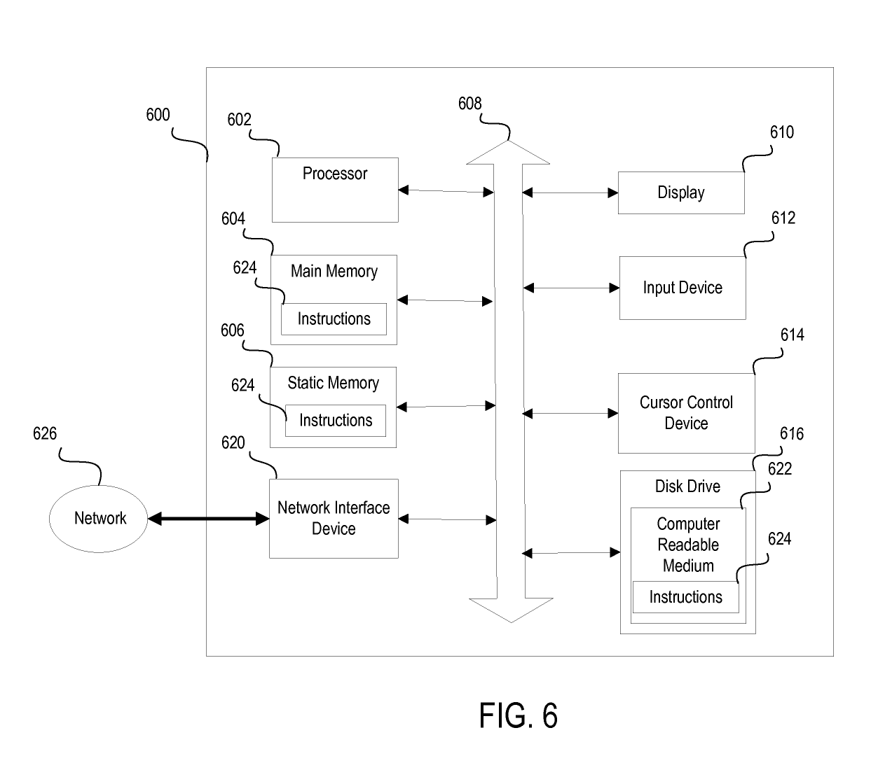

Referring to FIG. 6, an illustrative embodiment of a general computer system that may be used for one or more of the components shown in FIGS. 2-5, or in any other trading system configured to carry out the methods discussed above, is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 5, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used by investment management companies, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

A seller-advanced margin option has been described, which may be traded alongside a standard option where each party is initially responsible for their own margin requirements. The seller-advanced margin options are contingent claim contracts that provide exposure to an underlying market much in the same way as standard options but where the seller is required to finance the margin requirement of the buyer. This margin requirement of the buyer for a seller-advanced margin option may be based on a customer margin requirement provided by the specific exchange, and/or the regulatory agency for an exchange. The price of the seller-advanced margin option may reflect the cost of a standard option with comparable contract terms in addition to the cost of financing the buyer's deferred margin requirement.

An exchange system has been described which would recognize and route distinguishing information between standard option trade and seller-advanced margin option trades to respective seller and buyer clearing firms and the clearing corporation. A collateral management service for handling the tracking and notification of buyer and seller clearing firms involved in seller-advanced margin derivative trading, added to the standard clearing corporation functionality of managing risks of trades, or separately provided in a standalone system, is described. The collateral management service may track repayment obligations and handle management of clearing firm obligations for repayment of seller-advanced margins using initial margin and repayment formulas and automated electronic reminders provided either directly to the clearing corporation (in the case of a stand-alone service entity) or to the clearing firms involved in the seller-advanced margin option trade (in the case where the collateral management service is integrated into the OCC or in embodiments where it is a stand-alone entity). Although additional information above that which is typically provided in a transaction to the clearing corporation could allow specific contact and tracking of the option buyer and option seller, in one embodiment, each of the seller's clearing firm and buyer's clearing firm would contact the individual option seller and option buyer and interact with the clearing corporation on an aggregate margin option basis where the clearing corporation and/or CMS would not know the specific buyer or seller beyond knowing the particular clearing firm involved in the trade.

In addition to the new type of option where sellers provide an advance of the margin requirement for the buyer, and to the collateral management service functions for implementing such an advanced margin payment arrangement, different repayment schemes have been described. The repayment scheme may be held in abeyance until an expiration or closing of position for the seller-advanced margin option and a lump sum paid by the buyer to the option seller via the respective firms and/or the collateral management service. Alternatively, periodic repayments by the option buyer to the seller, again via the buyer's clearing firm and/or the collateral management service, may be initiated based on mark-to-market data for a variable periodic payment, or a straight line payment of equal amounts on a period basis. Tracking and policing of the repayment may be accomplished through the collateral management service in cooperation with the buyer's and seller's clearing firms.

It is intended that the foregoing detailed description be regarded as illustrative rather than limiting, and that it be understood that it is the following claims, including all equivalents, that are intended to define the spirit and scope of this invention.

We claim:

1. A computer-implemented method of managing a seller-advanced margin option on an exchange, the method comprising:
in a processor of a clearing entity associated with the exchange, wherein the clearing entity is configured to monitor aggregate margin risks of clearing firms associated with buyers and sellers of seller-advance margin options, the processor:
receiving from the exchange an automated message identifying a matched trade for a seller-advanced margin option between a buyer and a seller, wherein the automated message includes information identifying that the matched trade is for the seller-advanced margin option;
transmitting a first margin position notice communication to a clearing firm of the seller of the seller-advanced margin option, wherein the margin position notice communication comprises aggregate margin position information for all customers of the clearing firm of the seller, and wherein the aggregate margin position information includes a margin obligation of the seller totaling a sum of margin requirements for both the buyer and the seller of the matched trade of the seller-advanced margin option; and
subsequent to transmitting the first margin position notice, transmitting a second margin position notice to the clearing firm of the seller, the second margin position notice comprising second aggregate margin position information including a repayment by the buyer to the seller of at least a portion of the margin obligation of the buyer of the seller-advanced margin option.

2. The computer-implemented method of claim 1, wherein transmitting the second margin position notice to the clearing firm of the seller comprises transmitting the second notice in response to an expiration of the seller-advanced margin option.

3. The computer-implemented method of claim 1, wherein transmitting the second margin position notice to the clearing firm of the seller comprises transmitting the second notice in response to receipt of a message that the buyer has closed out a position in the seller-advanced margin option.

4. The computer-implemented method of claim 1, wherein transmitting the second margin position notice to the clearing firm of the seller comprises transmitting a plurality of second margin notices at a predetermined interval after receiving the automated notice identifying the matched trade and prior to expiration of, or closing out of a position in, the seller-advanced margin option, wherein the second margin notices each reflect information relating to repayment from the buyer to the seller of only a respective portion of the margin requirement of the buyer.

5. The computer-implemented method of claim 4, wherein the respective portion in each of the second notices are equal.

6. The computer-implemented method of claim 4, wherein the respective portion in each of the second notices differ and are calculated based on a current mark-to-market value of the seller-advanced margin option.

7. A collateral management system for monitoring aggregate margin risks of clearing firms associated with buyers and sellers of seller-advanced margin options traded on an exchange, the collateral management system comprising:
a communication interface for communicating electronically with the exchange and the clearing firms associated with the exchange;
a memory comprising margin calculation data; and
a processor in communication with the memory and communication interface, the processor configured to:
receive from the exchange an automated message identifying a matched trade for a seller-advanced margin option between a buyer and a seller, wherein the automated message includes information identifying that the matched trade is for the seller-advanced margin option;
transmit a first margin position notice communication to a clearing firm of the seller of the seller-advanced margin option, wherein the margin position notice communication comprises aggregate margin position information for all customers of the clearing firm of the seller, and wherein the aggregate margin position information includes a margin obligation of the seller totaling a sum of margin requirements for both the buyer and the seller of the matched trade of the seller-advanced margin option; and
subsequent to transmitting the first margin position notice, transmit a second margin position notice to the clearing firm of the seller, the second margin position notice comprising second aggregate margin position information including a repayment by the buyer to the seller of at least a portion of the margin obligation of the buyer of the seller-advanced margin option.

8. The collateral management system of claim 7, wherein the processor is configured to transmit the second margin position notice to the clearing firm of the seller in response to an expiration of the seller-advanced margin option.

9. The collateral management system of claim 7, wherein the processor is configured to transmit the second margin position notice to the clearing firm of the seller in response to receipt of a message that the buyer has closed out a position in the seller-advanced margin option.

10. The collateral management system of claim 7, wherein the processor is configured to transmit a plurality of second margin notices at a predetermined interval after receiving the automated notice identifying the matched trade and prior to expiration of, or closing out of a position in, the seller-advanced margin option, wherein each of the plurality of second margin notices reflect information relating to repayment from the buyer to the seller of only a respective portion of the margin requirement of the buyer.

11. The collateral management system of claim 10, wherein the respective portion in each of the second notices are equal.

12. The collateral management system of claim 10, wherein the respective portion in each of the plurality of second notices differ and the processor is configured to calculate each of the plurality of second notices based on a current mark-to-market value of the seller-advanced margin option.
